(19) United States
(12) Patent Application Publication
(10) Pub. No.: US 2013/0173275 A1
(43) Pub. Date: Jul. 4, 2013

(54) AUDIO ENCODING DEVICE AND AUDIO DECODING DEVICE

(71) Applicants: Zongxian Liu, Singapore (SG); Kok Seng Chong, Singapore (SG); Masahiro Oshikiri, Kanagawa (JP)

(72) Inventors: Zongxian Liu, Singapore (SG); Kok Seng Chong, Singapore (SG); Masahiro Oshikiri, Kanagawa (JP)

(73) Assignee: PANASONIC CORPORATION, Osaka (JP)

(21) Appl. No.: 13/822,810

(22) PCT Filed: Sep. 14, 2011
(86) PCT No.: PCT/JP2011/005171

§ 371 Date: Mar. 13, 2013

(30) Foreign Application Priority Data
Oct. 18, 2010 (JP) 2010-234088

(51) Int. Cl. G10L 19/06

(52) U.S. Cl. CPC G10L 19/06
USPC 704/500

(57) ABSTRACT

Provided is an audio encoding device that can suppress degradation of audio quality. Spectral coefficients of synthesized signal from CELP core layer are utilized to fulfill spectral gaps in error signal spectrum coefficients from a transform coding layer. By both spectral coefficients, decoded signal spectral coefficients are generated. The decoded signal spectral coefficients and the input signal spectral coefficients are divided into a plurality of sub bands. In each sub band, the energy of the input signal spectral coefficient corresponding to a zero decoded error signal spectral coefficient is calculated, and the energy of the decoded signal spectral coefficient corresponding to the zero decoding error signal spectral coefficient is calculated, and their energy ratio is calculated and is quantized and transmitted.

### TECHNICAL FIELD

The present invention relates to an audio coding apparatus and an audio decoding apparatus, and, for example, to an audio coding apparatus and audio decoding apparatus that employ hierarchical coding (code-excited linear prediction (CELP) and transform coding).

### BACKGROUND ART

With respect to audio coding, there are two main types of coding schemes, namely transform coding and linear prediction coding.

Transform coding involves a signal conversion from the time domain to the frequency domain, as in discrete Fourier transform (DFT), modified discrete cosine transform (MDCT), and/or the like. Spectral coefficients derived through signal conversion are quantized and coded. In the process of quantization or coding, the psychoacoustic model is ordinarily applied to determine the perceptual significances of the spectral coefficients, and the spectral coefficients are quantized or coded in accordance with their perceptual significances. MPEG MP3, MPEG, AAC (see Non-Patent Literature 1), Dolby AC3, and the like, are used widely for transform coding (transform codecs). Transform coding is effective for music, as well as audio signals in general. A simple configuration of a transform codec is shown in FIG. 1.

With respect to the encoder shown in FIG. 1, time domain signal S(n) is converted into frequency domain signal S(f) using a method of converting (101) from the time domain to the frequency domain, such as discrete Fourier transform (DFT), modified discrete cosine transform (MDCT), and/or the like.

A psychoacoustic model analysis is performed on frequency domain signal S(f), and a masking curve is derived (103). Frequency domain signal S(f) is quantized (102) in accordance with the masking curve derived through the psychoacoustic model analysis, thereby making quantization noise inaudible.

A quantized parameter is multiplexed (104) and sent to the decoder side.

With respect to the decoder shown in FIG. 1, all bit stream information is first demultiplexed (105). The quantized parameter is dequantized, and decoded spectral coefficient S˜(f) is reconfigured (106).

Decoded spectral coefficient S˜(f) is converted back to the time domain using a method of converting (107) from the frequency domain to the time domain, such as inverse discrete Fourier transform (IDFT), inverse modified discrete cosine transform (IMDCT), and/or the like, and decoded signal S˜(n) is reconfigured.

On the other hand, linear predictive coding derives a residual signal (excitation signal) by applying linear prediction to an input audio signal, making use of the predictability of audio signals in the time domain. For vocal regions having similarity with respect to time shifts based on pitch period, this modeling procedure is an extremely efficient expression. Subsequent to linear prediction, the residual signal is typically coded through two types of methods, namely TCX and CELP.

With respect to TCX (see Non-Patent Literature 2), the residual signal is converted to the frequency domain, and coding is performed. One widely used TCX codec is 3GPP AMR-WB+. A simple configuration of a TCX codec is shown in FIG. 2.

With respect to the encoder shown in FIG. 2, an LPC analysis is performed on the input signal (201). The LPC coefficient determined at the LPC analysis section is quantized (202), and a quantized parameter is multiplexed (207) and sent to the decoder side. Residual signal Sᵣ(n) is derived by applying LPC inverse filtering (204) to input signal S(n) using a dequantized LPC coefficient obtained at dequantization section (203).

Residual signal Sᵣ(n) is converted into residual signal spectral coefficient Sᵣ(f) (205) using a method of converting from the time domain to the frequency domain, such as discrete Fourier transform (DFT), modified discrete cosine transform (MDCT), and/or the like.

Residual signal spectral coefficient Sᵣ(f) is quantized (206), and a quantized parameter is multiplexed (207) and sent to the decoder side.

With respect to the decoder shown in FIG. 2, all bit stream information is first demultiplexed (208).

The quantized parameter is dequantized, and decoded residual signal spectral coefficient Sᵣ˜(f) is reconfigured (210).

Decoded residual signal spectral coefficient Sᵣ˜(f) is converted back to the time domain using a method of converting (211) from the frequency domain to the time domain, such as inverse discrete Fourier transform (IDFT), inverse modified discrete cosine transform (IMDCT), and/or the like, and decoded residual signal Sᵣ˜(n) is reconfigured.

Based on the dequantized LPC parameter from dequantization section (209), decoded residual signal Sᵣ˜(n) is processed with LPC synthesis filter (212) to obtain decoded signal S˜(n).

In CELP coding, the residual signal is quantized using a predetermined codebook. In order to further enhance the sound quality, the difference signal between the original signal and the LPC synthesis signal is typically converted to the frequency domain and further encoded. Examples of coding of such a configuration include ITU-T G.729.1 (see Non-Patent Literature 3) and ITU-T G.718 (see Non-Patent Literature 4). A simple configuration of hierarchical coding (embedded coding), which uses CELP at its core section, and transform coding is shown in FIG. 3.

With respect to the encoder shown in FIG. 3, CELP coding, which makes use of predictability in the time domain, is executed (301) on the input signal. Based on CELP coded parameters, a synthesized signal is reconfigured (302) by a local CELP decoder. By subtracting the synthesized signal from the input signal, error signal Sₑ(n) (the difference signal between the input signal and the synthesized signal) is obtained.

Error signal Sₑ(n) is converted into error signal spectral coefficient Sₑ(f) through a method of converting (303) from the time domain to the frequency domain, such as discrete Fourier transform (DFT), modified discrete cosine transform (MDCT), and/or the like.

Sₑ(f) is quantized (304), and a quantized parameter is multiplexed (305) and sent to the decoder side.

With respect to the decoder shown in FIG. 3, all bit stream information is first demultiplexed (306).

The quantized parameter is dequantized, and decoded error signal spectral coefficient Sₑ˜(f) is reconfigured (308).

Decoded error signal spectral coefficient Sₑ˜(f) is converted back to the time domain using a method of converting (309) from the frequency domain to the time domain, such as inverse discrete Fourier transform (IDFT), inverse modified discrete cosine transform (IMDCT), and/or the like, and decoded error signal Sₑ˜(n) is reconfigured.

Based on CELP coded parameters, the CELP decoder reconfigures synthesized signal S_{syn}(n) (307), and reconfigures decoded signal S˜(n) by adding CELP synthesized signal S_{syn}(n) and decoded error signal Sₑ˜(n).

Transform coding is ordinarily carried out using vector quantization.

Due to bit constraints, it is usually impossible to finely quantize all spectral coefficients. Spectral coefficients are often loosely quantized, where only a portion of the spectral coefficients are quantized.

By way of example, there are several types of vector quantization methods used in G.718 for spectral coefficient quantization, multi-rate lattice VQ (SMLVQ) (see Non-Patent Literature 5), Factorial Pulse Coding (FPC), and Band Selective-Shape Gain Coding (BS-SGC). Each vector quantization method is used in one of the transform coding layers. Due to bit constraints, only several of the spectral coefficients are selected and quantized at each layer.

### CITATION LIST

### Non-Patent Literature

NPL 1
Karl Heinz Brandenburg, “MP3 and AAC Explained”, AES 17^{th} International Conference, Florence, Italy, September 1999.
NPL 2
Lefebvre, et al., “High quality coding of wideband audio signals using transform coded excitation (TCX)”, IEEE International Conference on Acoustics, Speech, and Signal Processing, vol. 1, pp. I/193-I/196, April 1994
NPL 3
ITU-T Recommendation G.729.1 (2007) “G.729-based embedded variable bit-rate coder: An 8-32 kbit/s scalable wideband coder bitstream interoperable with G.729”
NPL 4
T. Vaillancourt et al, “ITU-T EV-VBR: A Robust 8-32 kbit/s Scalable Coder for Error Prone Telecommunication Channels”, in Proc. Eusipco, Lausanne, Switzerland, August 2008
NPL 5
M. Xie and J.-P. Adoul, “Embedded algebraic vector quantization (EAVQ) with application to wideband audio coding,” IEEE International Conference on Acoustics, Speech, and Signal Processing (ICASSP), Atlanta, Ga., U.S.A, 1996, vol. 1, pp. 240-243

### SUMMARY OF INVENTION

### Technical Problem

As shown in FIG. 4, in hierarchical coding, the input signal is processed through CELP and transform coding. Vector quantization is employed as a means of transform coding.

When the number of usable bits is limited, it may not always be possible to quantize all spectral coefficients in the transform coding layers, thus resulting in numerous zero spectral coefficients in the decoded spectral coefficients. Under more adverse conditions, a spectral gap occurs in the decoded spectral coefficients.

Due to the spectral gap in the decoded signal spectral coefficients, the decoded signal is perceived as a dull and muffled sound. In other words, the sound quality drops.

An object of the present invention is to provide an audio coding apparatus and audio decoding apparatus that are capable of mitigating sound quality degradation.

### Solution to Problem

With the present invention, a spectral gap caused by loose quantization is closed.

As shown in FIG. 5, with the present invention, spectral envelope shaping is performed with respect to synthesized signal spectral coefficients from the CELP core layer, and the shaped synthesized signal is used to close (fill) spectral gaps of transform coding layers.

Details of a spectral envelope shaping process are presented below.

First, a process of an audio coding apparatus will be presented. (1) Decoded error signal spectral coefficient Sₑ˜(f) of the transform coding layer is reconfigured. (2) Decoded signal spectral coefficient S˜(f) is reconfigured by adding synthesized signal spectral coefficient S_{syn}(f) from the CELP core layer and decoded error signal spectral coefficient Sₑ˜(f), such as that given by the equation below, from the transform coding layer.

[1]

\tilde{S}(f)=\tilde{S}ₑ(f)+S_{syn}(f) (Equation 1)

where \tilde{S}ₑ(f) is the decoded error signal spectral coefficient, S_{syn}(f) is the synthesized signal spectral coefficient from the CELP core layer, and \tilde{S}(f) is the decoded signal spectral coefficient.

(3) Decoded signal spectral coefficient S˜(f) and input signal spectral coefficient S(f) are both divided into a plurality of subbands. (4) For each subband, the energy of input signal spectral coefficient S(f) corresponding to zero decoded error signal spectral coefficient Sₑ˜(f) is calculated as indicated by the equation below. The term “zero decoded error signal spectral coefficient” refers to a decoded error signal spectral coefficient whose spectral coefficient value is zero.

$$\begin{matrix}( Equation 2 ) & \\ {E}_{org \_ i} = {\sum }_{f = sb \_ start [ i ]}^{sb \_ end [ i ]} {S ( f )}^{2} if {\tilde{S}}_{e} ( f ) = 0 & [ 2 ]\end{matrix}$$

where E_{org}_{_{—}}ᵢ is the energy of the input signal spectral coefficient corresponding to the zero decoded error signal spectral coefficient in subband i, sb_start[i] is the minimum frequency of subband i, sb_end[i] is the maximum frequency of subband i, S(f) is the input signal spectral coefficient, and \tilde{S}ₑ(f) is the decoded error signal spectral coefficient.

(5) For each subband, the energy of decoded signal spectral coefficient S˜(f) corresponding to zero decoded error signal spectral coefficient Sₑ˜(f) is calculated as indicated by the equation below.

$$\begin{matrix}( Equation 3 ) & \\ {E}_{dec \_ i} = {\sum }_{f = sb \_ start [ i ]}^{sb \_ end [ i ]} {\tilde{S} ( f )}^{2} if {\tilde{S}}_{e} ( f ) = 0 & [ 3 ]\end{matrix}$$

where E_{dec}_{_{—}}ᵢ is the energy of the decoded spectral coefficient corresponding to the zero decoded error signal spectral coefficient in subband i, sb_start[i] is the minimum frequency of subband i, sb_end[i] is the maximum frequency of subband i, \tilde{S}(f) is the decoded signal spectrum, and \tilde{S}Sₑ(f) is the decoded error signal spectrum.

(6) For each band, an energy ratio such as that given by the equation below is determined.

[4]

Gᵢ=E_{org}_{_{—}}ᵢ/E_{dec}_{_{—}}ᵢ (Equation 4)

where E_{org}_{_{—}}ᵢ is the energy of the input signal spectral coefficient corresponding to the zero decoded error signal spectral coefficient in subband i, E_{dec}_{_{—}}ᵢ is the energy of the decoded spectral coefficient corresponding to the zero decoded error signal spectral coefficient in subband i, and Gᵢ is the energy ratio of the above-mentioned two energies with respect to subband i.

(7) The energy ratio is quantized and sent to the audio decoding apparatus side.

Next, a process of an audio decoding apparatus will be presented. (1) The energy ratio is dequantized. (2) The synthesized signal spectral coefficient from the CELP core layer is shaped in accordance with a spectral envelope shaping parameter derived from the decoded energy ratio. (3) The spectral-envelope-shaped spectrum is used to close the spectral gap of the transform coding layer as indicated in the equation below.

[5]

if \tilde{S}ₑ(f)=0,

\tilde{S}ₑ(f)=S_{syn}(f)*(\sqrt{\tilde{G}ᵢ}−1)

fε[sb_start[i],sb_end[i]] (Equation 5)

where \tilde{S}ₑ(f) is the decoded error spectral coefficient, S_{syn}(f) is the synthesized signal spectral coefficient from the CELP core layer, and \tilde{S}(f) is the decoded signal spectral coefficient, \tilde{G}ᵢ is the decoded energy ratio with respect to subband i, sb_start[i] is the minimum frequency of subband i, and sb_end[i] is the maximum frequency of subband i.

### Advantageous Effects of Invention

With the present invention, by closing the spectral gap in the spectrum, dull and muffled sounds in the decoded signal may be prevented, thereby mitigating sound quality degradation.

### BRIEF DESCRIPTION OF DRAWINGS

FIG. 1 is a diagram showing a simple configuration of a transform codec;

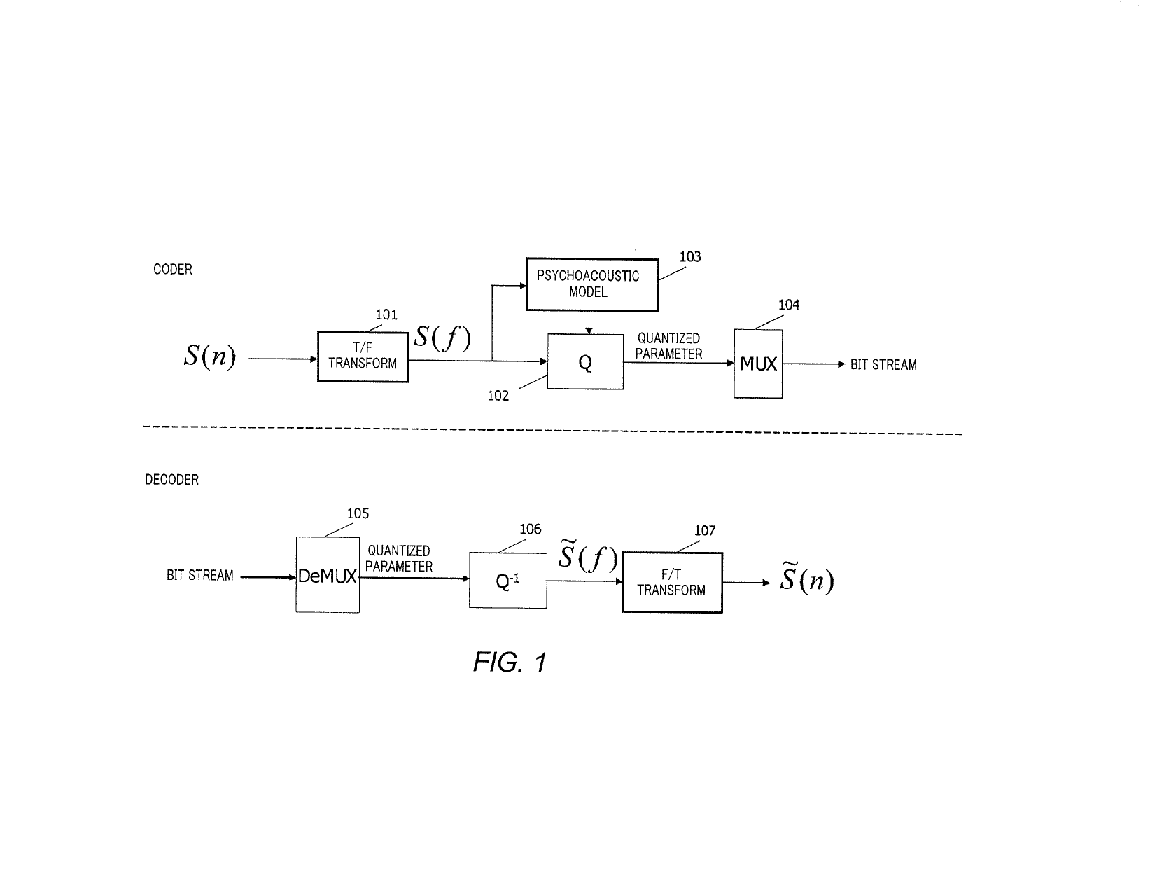

FIG. 2 is a diagram showing a simple configuration of a TCX codec;

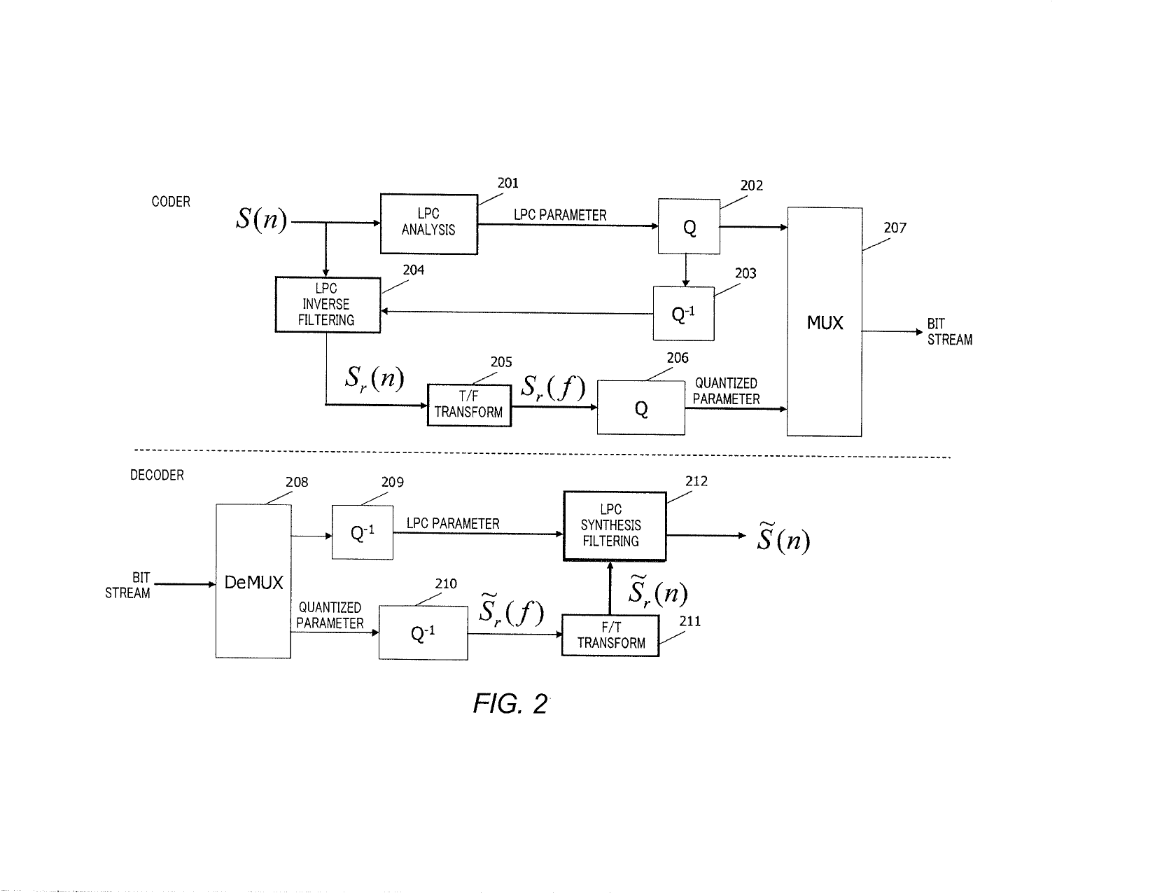

FIG. 3 is a diagram showing a simple configuration of a hierarchical codec (CELP and transform coding);

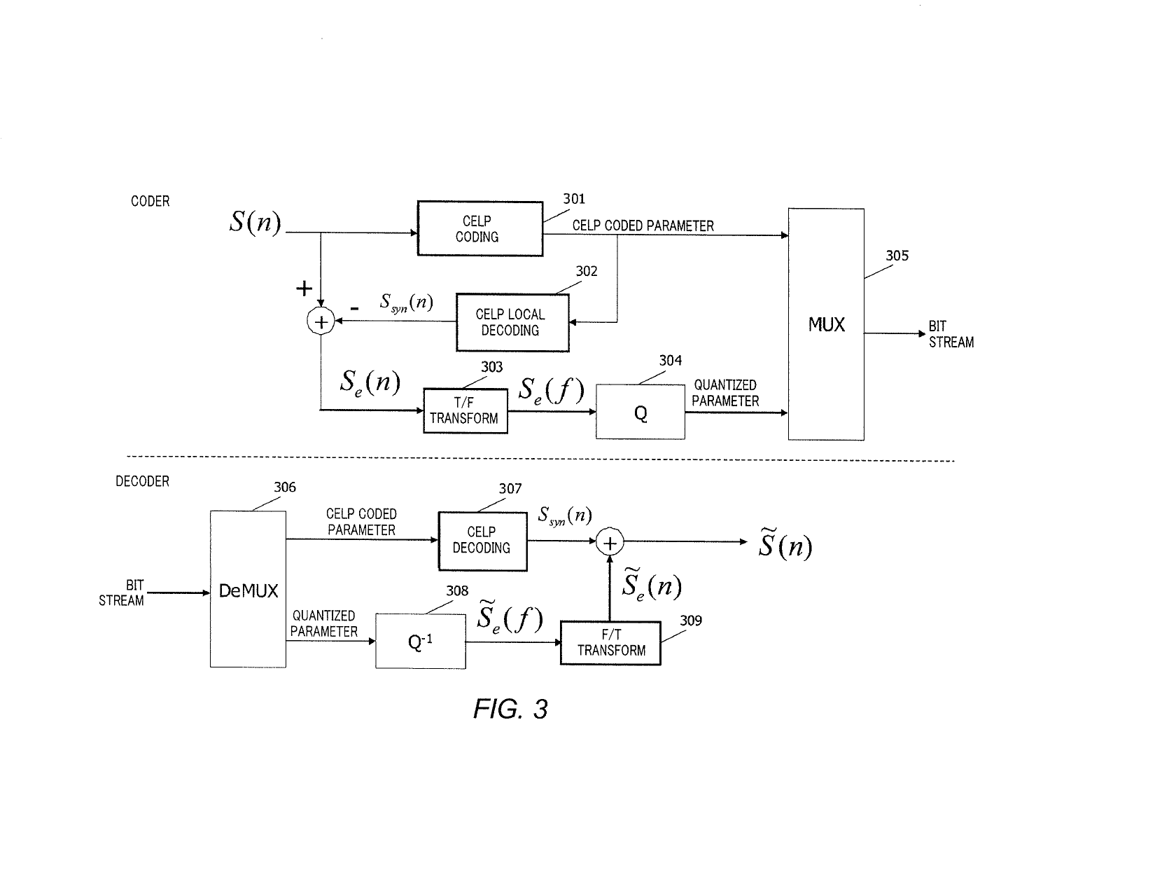

FIG. 4 is a diagram showing a problem with hierarchical codecs (CELP and transform coding);

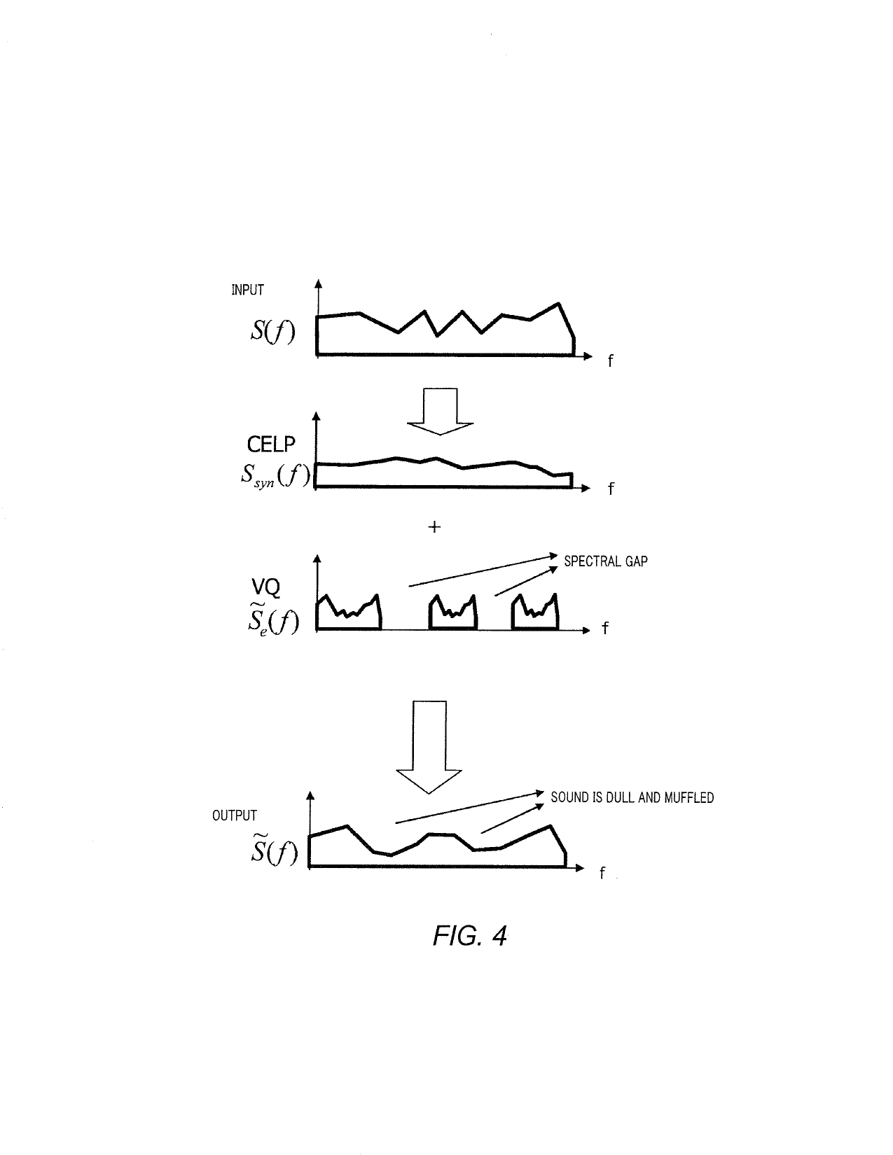

FIG. 5 is a diagram showing a solution to a problem of the present invention;

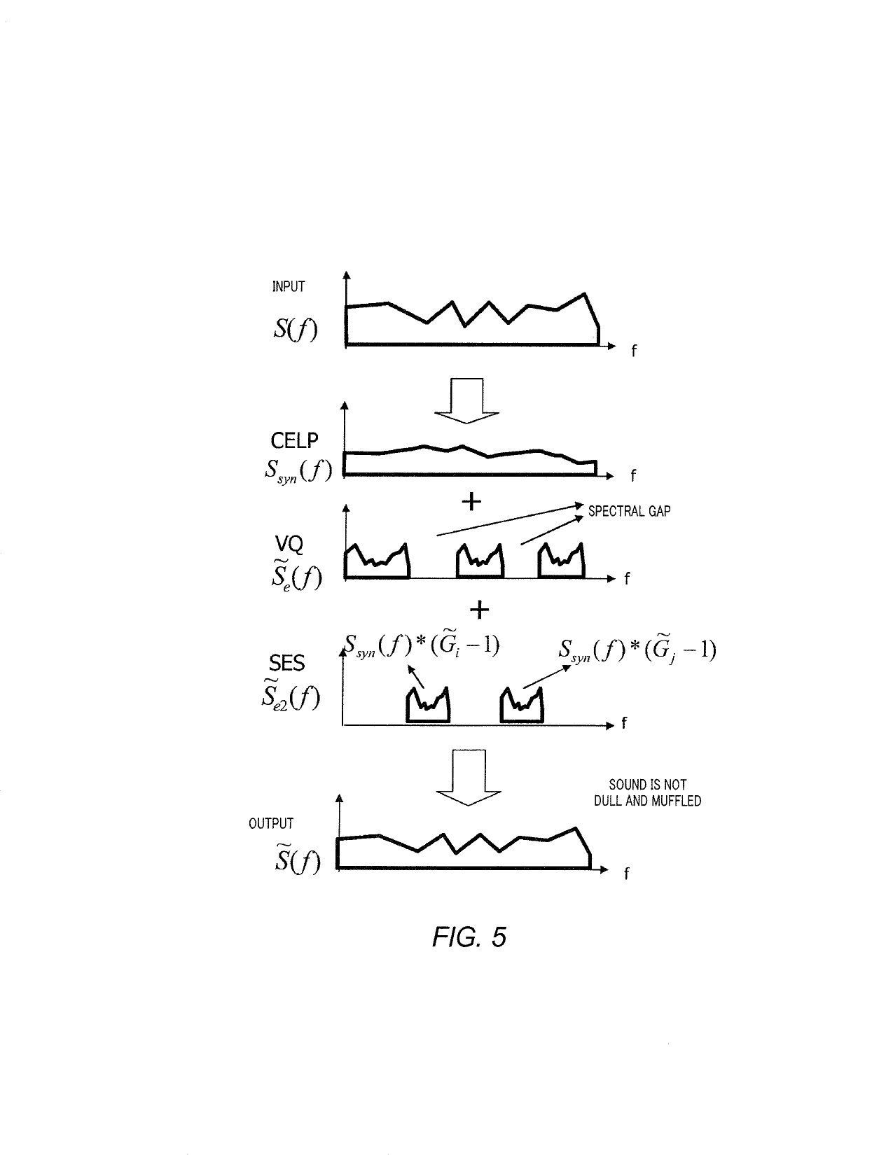

FIG. 6 is a diagram showing a configuration of an audio coding apparatus according to Embodiment 1 of the present invention;

FIG. 7 is a diagram showing a configuration of a spectral envelope extraction section according to Embodiment 1 of the present invention;

FIG. 8 is a diagram showing a configuration of a spectrum division method according to Embodiment 1 of the present invention;

FIG. 9 is a diagram showing a configuration of an audio decoding apparatus according to Embodiment 1 of the present invention;

FIG. 10 is a diagram showing a configuration of a spectral envelope shaping section according to Embodiment 1 of the present invention;

FIG. 11 is a diagram showing a configuration of a spectral envelope extraction section according to Embodiment 2 of the present invention;

FIG. 12 is a diagram showing a configuration of a spectral envelope shaping section according to Embodiment 2 of the present invention;

FIG. 13 is a diagram showing a configuration of a spectral envelope extraction section according to Embodiment 3 of the present invention;

FIG. 14 is a diagram showing a configuration of a spectral envelope extraction section according to Embodiment 4 of the present invention; and

FIG. 15 is a diagram showing a configuration of a spectral envelope shaping section according to Embodiment 4 of the present invention.

### DESCRIPTION OF EMBODIMENTS

Embodiments of the present invention are described in detail below with reference to the drawings. With respect to the various embodiments, like elements are designated with like numerals, while omitting redundant descriptions thereof.

### Embodiment 1

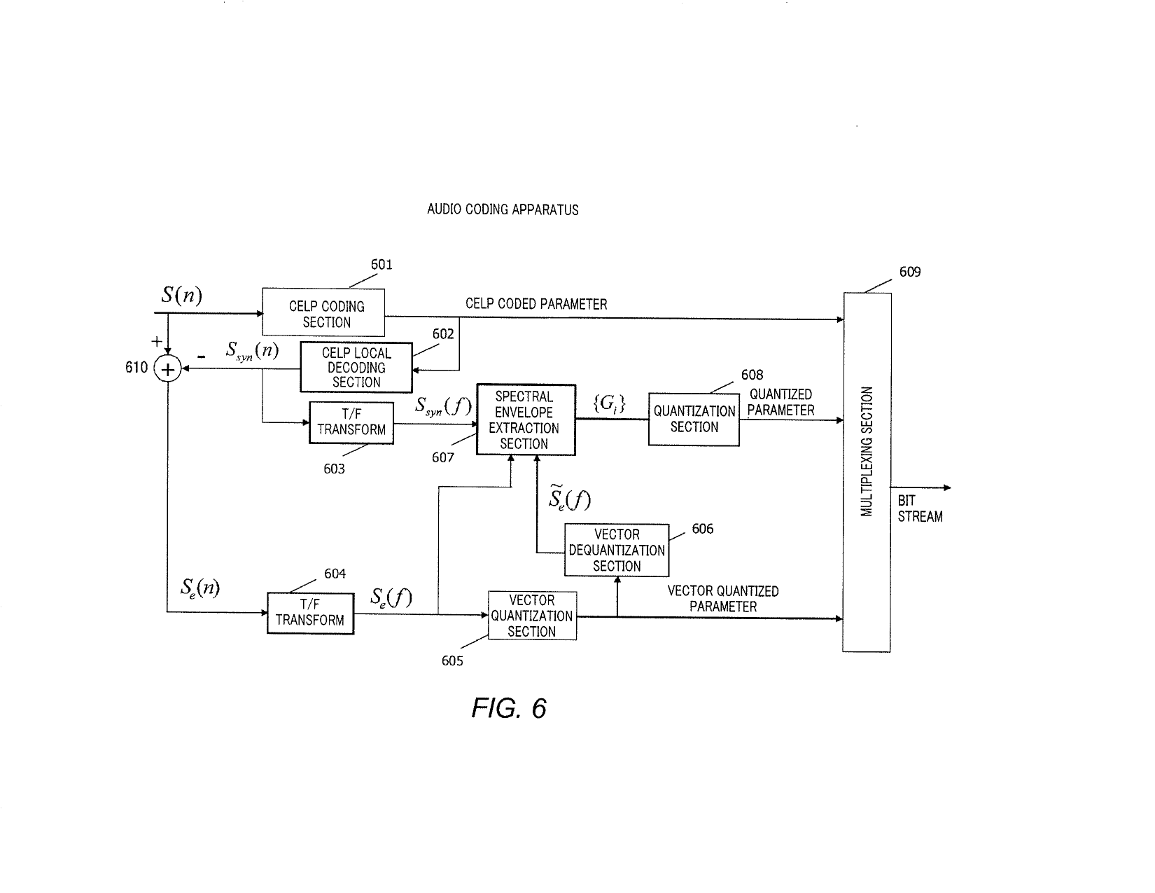

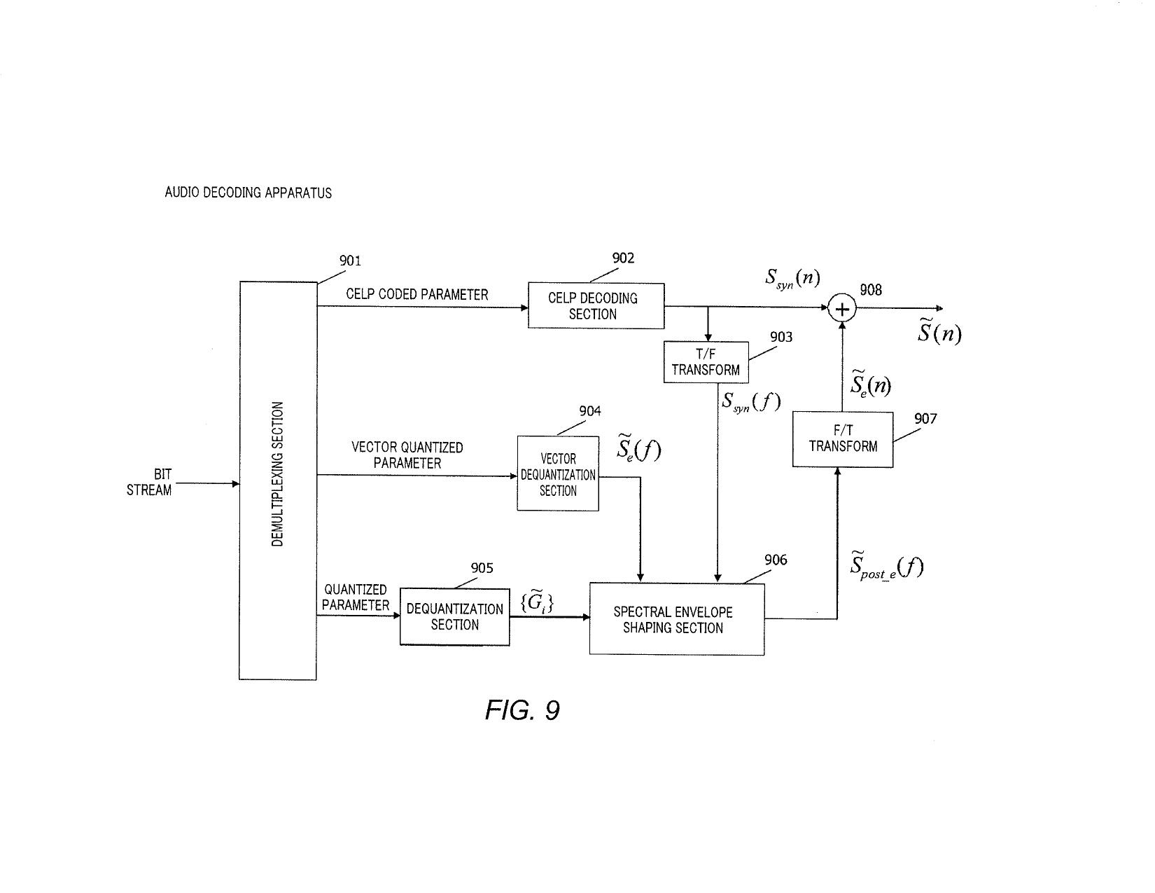

FIG. 6 is a diagram showing a configuration of an audio coding apparatus according to the present embodiment. FIG. 9 is a diagram showing a configuration of an audio decoding apparatus according to the present embodiment. FIG. 6 and FIG. 9 depict cases where the present invention is applied to hierarchical coding (hierarchical coding, embedded coding) of CELP and transform coding.

With respect to the audio coding apparatus shown in FIG. 6, CELP coding section 601 performs coding making use of signal predictability in the time domain.

CELP local decoding section 602 reconfigures a synthesized signal using a CELP coded parameter. Multiplexing section 609 multiplexes the CELP coded parameter, and sends it to an audio decoding apparatus.

Subtractor 610 derives error signal Sₑ(n) (the difference signal between the input signal and the synthesized signal) by subtracting the synthesized signal from the input signal.

T/F transform sections 603 and 604 convert the synthesized signal and error signal Sₑ(n) into a synthesized signal spectral coefficient and error signal spectral coefficient Sₑ(f) using a method of converting from the time domain to the frequency domain, e.g., discrete Fourier transform (DFT), modified discrete cosine transform (MDCT), and/or the like.

Vector quantization section 605 carries out vector quantization on error signal spectral coefficient Sₑ(f), and generates a vector quantized parameter.

Multiplexing section 609 multiplexes the vector quantized parameter and sends it to the audio decoding apparatus.

At the same time, vector dequantization section 606 dequantizes the vector quantized parameter, and reconfigures decoded error signal spectral coefficient Sₑ˜(f).

Spectral envelope extraction section 607 extracts spectral envelope shaping parameter {Gᵢ} from the synthesized signal spectral coefficient, the error signal spectral coefficient, and the decoded error signal spectral coefficient.

Quantization section 608 quantizes spectral envelope shaping parameter {Gᵢ}. Multiplexing section 609 multiplexes the quantized parameter, and sends it to the audio decoding apparatus.

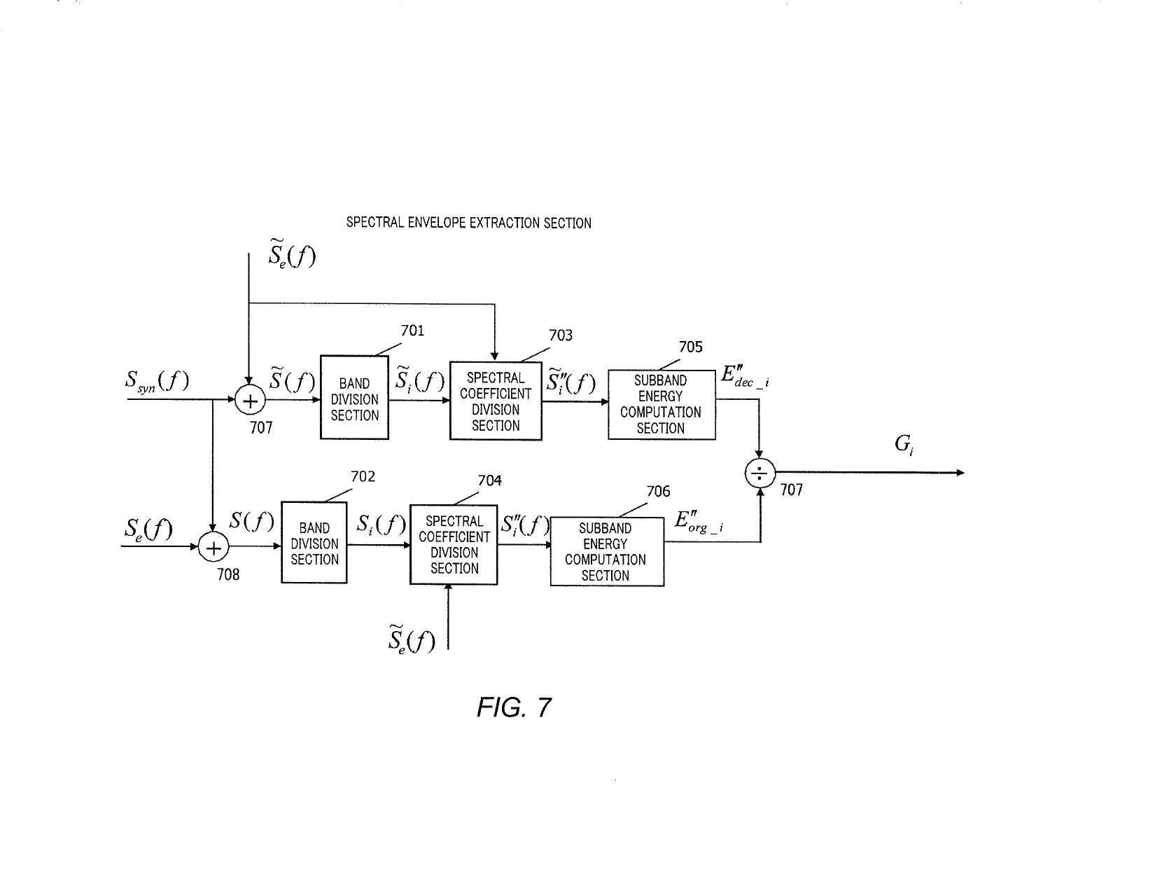

FIG. 7 shows details of spectral envelope extraction section 607.

As shown in FIG. 7, the input to spectral envelope extraction section 607 includes synthesized signal spectral coefficient S_{syn}(f), error signal spectral coefficient Sₑ(f), and decoded error signal spectral coefficient Sₑ˜(f). The output includes spectral envelope shaping parameter {Gᵢ}.

First, adder 708 adds synthesized signal spectral coefficient S_{syn}(f) and error signal spectral coefficient Sₑ(f) to form input signal spectral coefficient S(f). Adder 707 adds synthesized signal spectral coefficient S_{syn}(f) and decoded error signal spectral coefficient Sₑ˜(f) to form decoded signal spectral coefficient S˜(f).

Next, band division sections 702 and 701 divide input signal spectral coefficient S(f) and decoded signal spectral coefficient S˜(f) into a plurality of subbands.

Next, spectral coefficient division sections 704 and 703 reference the decoded error signal spectral coefficient, and classify each of the input signal spectral coefficient and the decoded signal spectral coefficient into two classes. First, the input signal spectral coefficient will be described. With respect to each subband, spectral coefficient division section 704 performs classification according to two types, where an input signal spectral coefficient corresponding to a band for which the decoded signal spectral coefficient value is zero is classified as a zero input signal spectral coefficient, and where an input signal spectral coefficient corresponding to a band for which the decoded signal spectral coefficient value is not zero is classified as a non-zero input signal spectral coefficient. Spectral coefficient division section 703 applies to the decoded signal spectral coefficient a similar classification based on the decoded error signal spectral coefficient to determine a zero decoded error signal spectral coefficient and a non-zero decoded signal spectral coefficient.

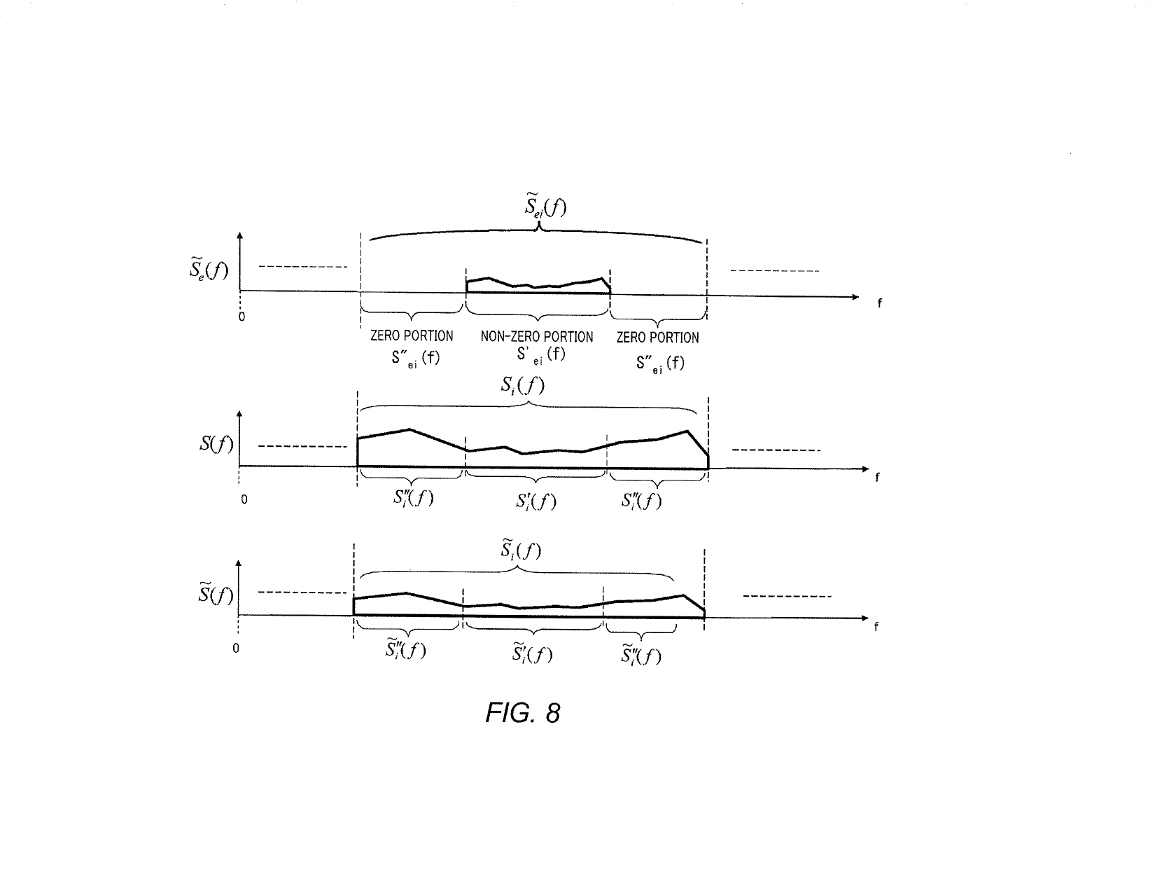

As shown in FIG. 8, spectral coefficient division section 704 divides the ith subband into a band for which the decoded error spectral coefficient value is zero (the zero decoded error signal spectral coefficient) and a band for which the decoded error spectral coefficient value is no zero (the non-zero decoded error signal spectral coefficient). In a manner corresponding to zero decoded error signal spectral coefficient S″ₑᵢ˜(f) and non-zero decoded error signal spectral coefficient S′ₑᵢ˜(f), input signal spectral coefficient Sᵢ(f) of the ith subband is so classified that a spectral coefficient included in the band where zero decoded error signal spectral coefficient S″ₑᵢ˜(f) is located is classified as zero input signal spectral coefficient S″ᵢ(f), while a spectral coefficient included in the band where non-zero decoded error signal spectral coefficient S′ₑᵢ˜(f) is located is classified as non-zero input signal spectral coefficient S′ᵢ(f). Similarly, in a manner corresponding to zero decoded error signal spectral coefficient S″ₑᵢ˜(f) and non-zero decoded error signal spectral coefficient S′ₑᵢ˜(f), spectral coefficient division section 703 classifies decoded signal spectral coefficient Sᵢ˜(f) of the ith subband into zero decoded signal spectral coefficient S″ᵢ˜(f) and non-zero decoded signal spectral coefficient S′ᵢ˜(f).

Subband energy computation sections 706 and 705 calculate energy for each subband with respect to zero input signal spectral coefficient S″ᵢ(f) and zero decoded signal spectral coefficient S″ᵢ˜(f). Energy is calculated in the manner indicated by the equation below.

$$\begin{matrix}( Equation 6 ) & \\ {E}_{org \_ i}^{″} = {\sum }_{f = 0}^{{N}_{zero} [ i ] - 1} {{S}_{i}^{″} ( f )}^{2} & [ 6 ]\end{matrix}$$

where E″_{org}_{_{—}}ᵢ is the energy of the zero input signal spectral coefficients in subband i, S″ᵢ(f) is the zero input signal spectral coefficient in subband i, and N_{zero}[i] is the number of zero input signal spectral coefficients in subband i.

$$\begin{matrix}( Equation 7 ) & \\ {E}_{dec \_ i}^{″} = {\sum }_{f = 0}^{{N}_{zero} [ i ] - 1} {{\tilde{S}}_{i}^{″} ( f )}^{2} & [ 7 ]\end{matrix}$$

where E″_{dec}_{_{—}}ᵢ is the energy of the zero decoded signal spectral coefficients in subband i, \tilde{S}″ᵢ(f) is the zero decoded signal spectral coefficient in subband i, and N_{zero}[i] is the number of zero decoded signal spectral coefficients in subband i.

The ratio between the above-mentioned two energies is calculated as follows.

[8]

Gᵢ=E″_{org}_{_{—}}ᵢ/E″_{dec}_{_{—}}ᵢ (Equation 8)

where E″_{org}_{_{—}}ᵢ is the energy of the zero input signal spectral coefficients in subband i, E″_{dec}_{_{—}}ᵢ is the energy of the zero decoded signal spectral coefficients in subband i, and Gᵢ is the energy ratio between the above-mentioned two energies with respect to subband i.

This {Gᵢ} is outputted as a spectral envelope shaping parameter from divider 707.

With respect to the audio decoding apparatus shown in FIG. 9, demultiplexing section 901 first demultiplexes all bit stream information, generates a CELP coded parameter, a vector quantized parameter, and a quantized parameter, and outputs them to CELP decoding section 902, vector dequantization section 904, and dequantization section 905, respectively.

By means of the CELP coded parameter, CELP decoding section 902 reconfigures synthesized signal S_{syn}(n).

T/F transform section 903 converts synthesized signal S_{syn}(n) into decoded signal spectral coefficient S_{syn}(f) using a method of converting from the time domain to the frequency domain, e.g., discrete Fourier transform (DFT), modified discrete cosine transform (MDCT), and/or the like.

Vector dequantization section 904 dequantizes the vector quantized parameter, and reconfigures decoded error signal spectral coefficient Sₑ˜(f).

Dequantization section 905 dequantizes the quantized parameter intended for the spectral envelope shaping parameter, and reconfigures decoded spectral envelope shaping parameter {Gᵢ˜}.

Spectral envelope shaping section 906 closes the spectral gap of the decoded error signal spectral coefficient by means of decoded spectral envelope shaping parameter {Gᵢ˜}, synthesized signal spectral coefficient S_{syn}(f), and decoded error signal spectral coefficient Sₑ˜(f) to generate post-processing error signal spectral coefficient Sₚₒₛₜ₋ₑ˜(f).

F/T transform section 907 transforms post-processing error signal spectral coefficient Sₚₒₛₜ₋ₑ˜(f) back to the time domain, and reconfigures decoded error signal Sₑ˜(n) using a method of converting from the frequency domain to the time domain, such as inverse discrete Fourier transform (IDFT), inverse modified discrete cosine transform (IMDCT), and/or the like.

Adder 908 reconfigures decoded signal S˜(n) by adding synthesized signal S_{syn}(n) and decoded error signal Sₑ˜(n).

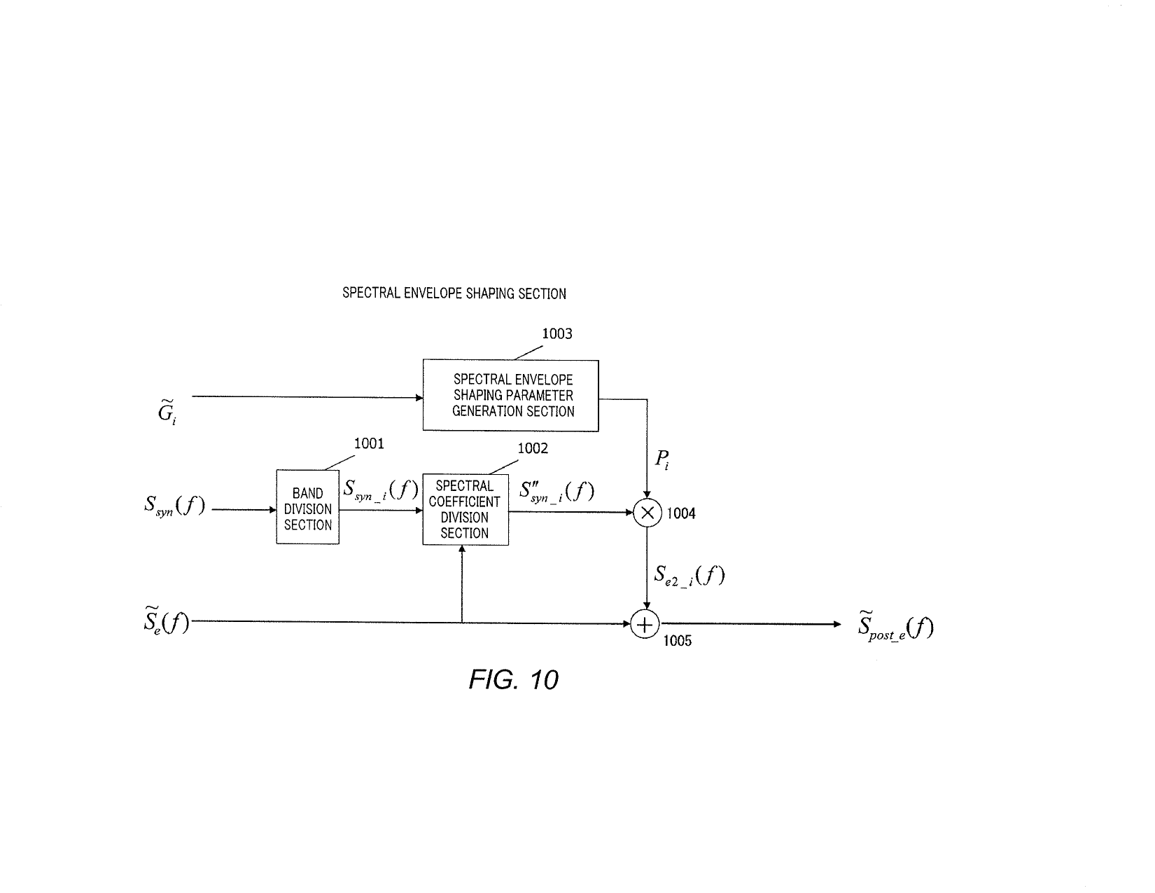

FIG. 10 shows details of spectral envelope shaping section 906.

As shown in FIG. 10, the input to spectral envelope shaping section 906 includes decoded spectral envelope shaping parameter {Gᵢ˜} synthesized signal spectral coefficient S_{syn}(f), and decoded error signal spectral coefficient Sₑ˜(f). The output includes post-processing error signal spectral coefficient Sₚₒₛₜ₋ₑ˜(f).

Band division section 1001 divides synthesized signal spectral coefficient S_{syn}(f) into a plurality of subbands.

Next, as shown in FIG. 8, spectral coefficient division section 1002 references the decoded error signal spectral coefficient, and classifies synthesized signal spectral coefficients into two classes. Specifically, with respect to each subband, spectral coefficient division section 1002 performs classification according to two types, such that a synthesized signal spectral coefficient corresponding to a band for which the decoded error signal spectral coefficient value is zero is classified as zero synthesized signal spectral coefficient S″_{syn}_{_{—}}ᵢ(f), and that a synthesized signal spectral coefficient corresponding to a band for which the decoded error signal spectral coefficient value is not zero is classified as non-zero synthesized signal spectral coefficient S′_{syn}_{_{—}}ᵢ(f).

Spectral envelope shaping parameter generation section 1003 processes decoded spectral envelope shaping parameter Gᵢ˜, and calculates an appropriate spectral envelope shaping parameter. One such method is presented through the equation below.

[9]

Pᵢ\sqrt{\tilde{G}ᵢ}−1 (Equation 9)

where Pᵢ is the derived spectral envelope shaping parameter, and \tilde{G} is the decoded spectral envelope shaping parameter of the ith subband.

Then, as indicated by the following equations, the synthesized signal spectral coefficients from the CELP layer are shaped by multiplier 1004 in accordance with the spectral envelope shaping parameter, and a post-processing error signal spectrum is generated by adder 1005.

[10]

if \tilde{S}ₑ(f)=0,

\tilde{S}ₚₒₛₜ_{_{—}}ₑ(f)=S_{syn}(f)*Pᵢ (Equation 10)

[11]

if \tilde{S}ₑ(f)!=0,

\tilde{S}ₚₒₛₜ_{_{—}}ₑ(f)=\tilde{S}ₑ(f)

fε[sb_start[i],sb_end[i]] (Equation 11)

where \tilde{S}ₑ(f) is the decoded error signal spectral coefficient, S_{syn}(f) is the synthesized signal spectral coefficient from the CELP layer, \tilde{S}(f) is the decoded signal spectral coefficient, Pᵢ is the derived spectral envelope shaping parameter, \tilde{S}Sₚₒₛₜ_{_{—}}ₑ(f) is the post-processing error signal spectral coefficient, sb_start[i] is the minimum frequency of the ith subband, and sb_end[i] is the maximum frequency of the ith subband.

<Variation>

With respect to the coding section, after at least one of the zero input signal spectral coefficient and the zero decoded signal spectral coefficient has been classified, and, with respect to the decoding section, after the zero synthesized signal spectral coefficient has been classified, band division may be performed taking these classification results into account. This enables subbands to be determined efficiently.

The present invention may be applied to a configuration where the number of bits available for spectral envelope shaping parameter quantization is variable from frame to frame. By way of example, this may include cases where a variable bit rate coding scheme, or a scheme in which the number of bits quantized at vector quantization section 605 in FIG. 6 varies from frame to frame, is used. In such cases, band division may be performed in accordance with the magnitude of the bit count available for spectral envelope shaping parameter quantization. By way of example, if a large number of bits are available, more spectral envelope shaping parameters may be quantized (i.e., a greater resolution may be achieved) by performing band division into a greater number of subbands. Conversely, if few bits are available, fewer spectral envelope shaping parameters are quantized (i.e., a lesser resolution is achieved) by performing band division into fewer subbands. By thus adaptively varying the number of subbands in accordance with the number of available bits, it becomes possible to quantize spectral envelope shaping parameters in numbers commensurate with the number of bits available, and to improve sound quality.

In quantizing spectral envelope shaping parameters, quantization may be performed in order from the higher frequency bands to the lower frequency bands. The reason being that, with respect to low frequency bands, CELP is able to code audio signals extremely efficiently through linear prediction modeling. Accordingly, when employing CELP in the core layer, it is perceptually more important to close the spectral gap of the high frequency bands.

If the number of bits available for spectral envelope shaping parameter quantization falls short, a spectral envelope shaping parameter having a large Gi value (Gᵢ>1) or small Gi value (Gᵢ<1) may be selected, and sent to the decoder side with quantization being performed only on the selected spectral envelope shaping parameter. In other words, what this signifies is that spectral envelope shaping parameters are quantized only with respect to subbands for which there is a large difference between the energy of the zero input signal spectral coefficients and the energy of the zero decoded signal spectral coefficients. Since this means that information of subbands that result in greater perceptual improvement will be selected and quantized, sound quality may be improved. In the case above, a flag indicating the subband of the selected energy is sent.

In quantizing spectral envelope shaping parameters, quantization may be performed with a bound provided so that the spectral envelope shaping parameter decoded after quantization does not exceed the value of the spectral envelope shaping parameter subject to quantization. Consequently, the post-processing error signal spectral coefficient that closes the spectral gap may be prevented from becoming unnecessarily large, and sound quality may be improved.

### Embodiment 2

In the case of a configuration where coding is performed at a low bit rate, coding accuracy is sometimes insufficient even for bands where there is no spectral gap (i.e., bands coded at a transform coding layer), resulting in a large coding error relative to the input signal spectral coefficient. Under such conditions, it is possible to improve sound quality by applying spectral envelope shaping to bands where there is no spectral gap, just like it is applied to bands where there is a spectral gap. Furthermore, in this case, greater sound quality improving effects are attained when spectral envelope shaping is carried out with respect to bands in which there is no spectral gap, separately from bands in which there is a spectral gap.

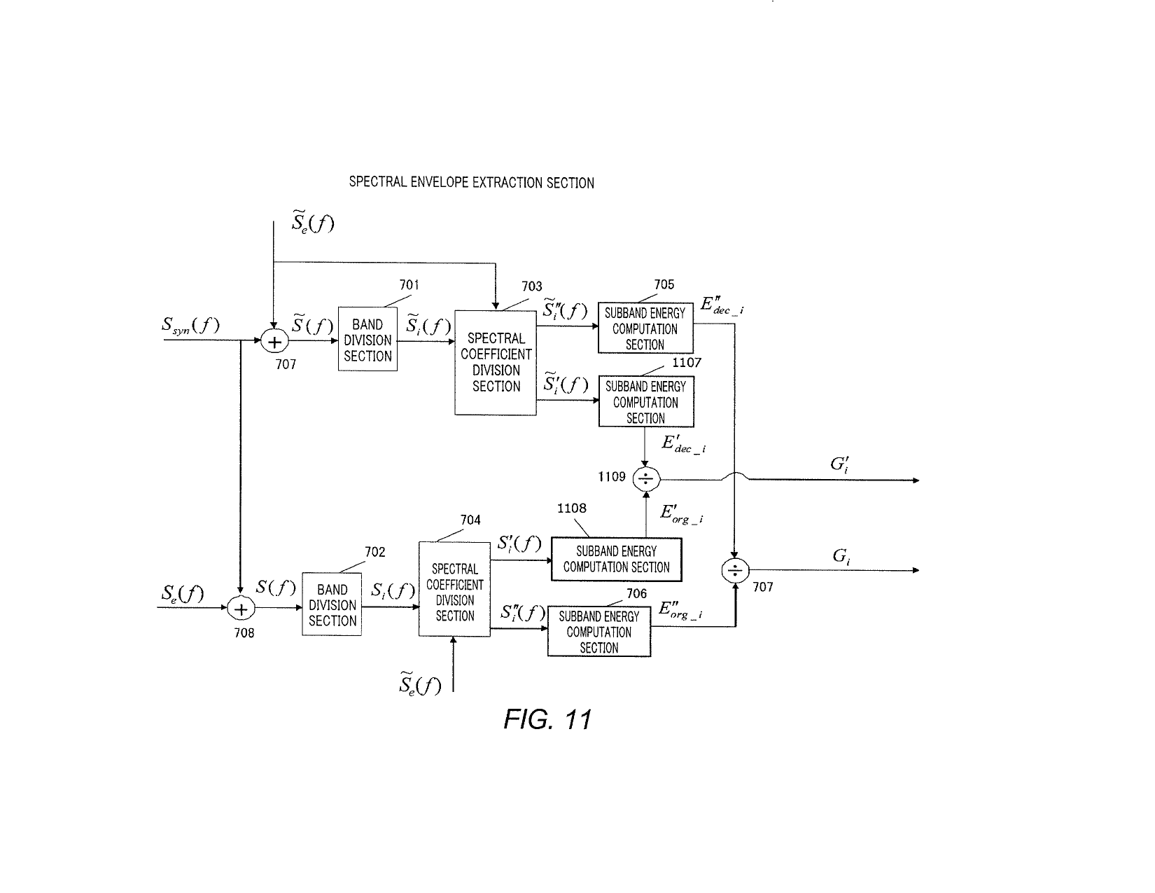

A configuration of a spectral envelope extraction section according to the present embodiment is shown in FIG. 11. It differs from FIG. 7 in that subband energy computation sections 1108 and 1107 perform energy computations also with respect to non-zero input signal spectral coefficients and non-zero decoded signal spectral coefficients, and in that divider 1009 also outputs, as a spectral envelope shaping parameter, the energy ratio computed here.

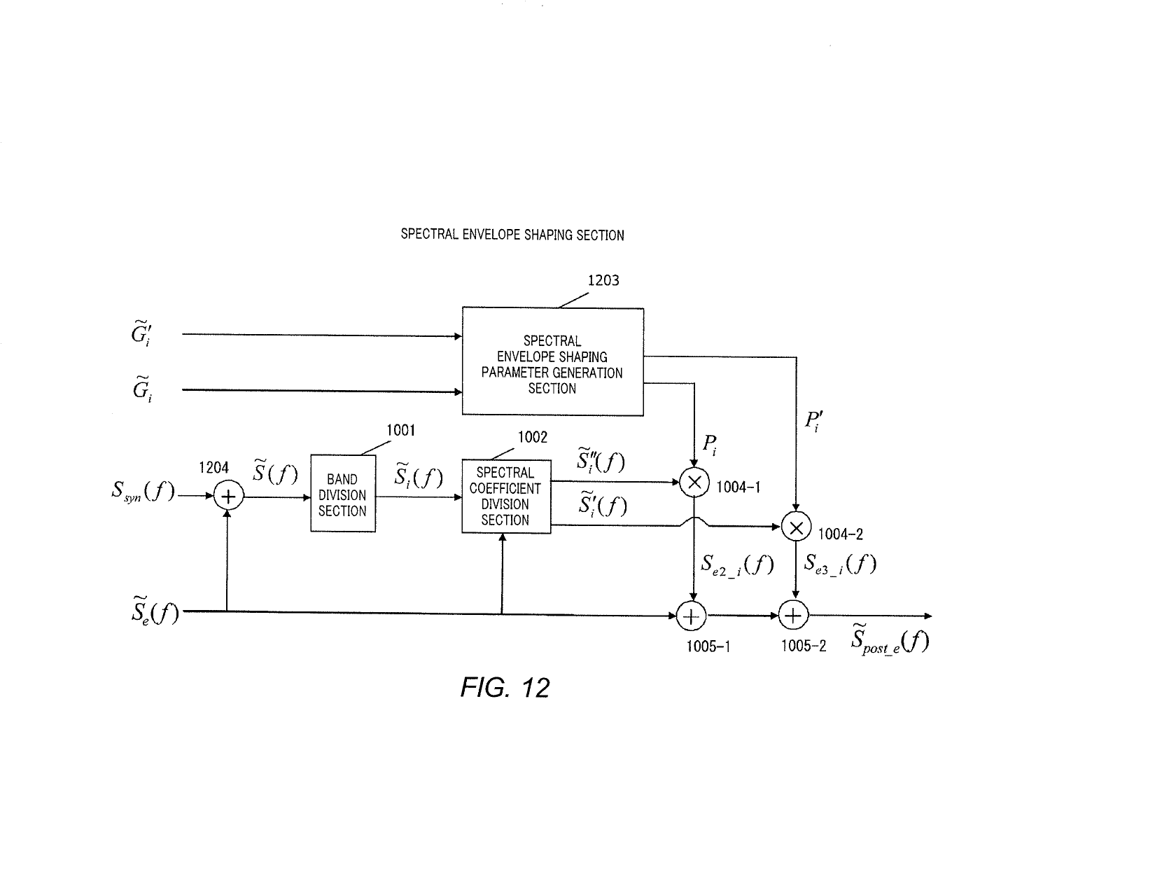

A configuration of a spectral envelope shaping section of the present embodiment is shown in FIG. 12. It differs from FIG. 10 in that a spectral envelope shaping parameter for a band in which there is no spectral gap is also decoded, and in that this is also used to generate a post-processing error signal spectral coefficient.

As shown in FIG. 12, spectral envelope shaping parameter generation section 1203 processes decoded spectral envelope shaping parameter G′ᵢ˜ intended for a band in which there is no spectral gap, and calculates an appropriate shaping parameter. One such method is presented through the equation below.

[12]

P′ᵢ={square root over (\tilde{G}′ᵢ−1 (Equation 12)

where P′ᵢ is the derived spectral envelope shaping parameter, and \tilde{G}′ᵢ is the spectral envelope shaping parameter of the ith subband.

Adder 1204 adds the synthesized signal spectral coefficient and the decoded error signal spectral coefficient to form the decoded signal spectral coefficient as indicated by the equation below.

[13]

\tilde{S}(f)=\tilde{S}ₑ(f)S_{syn}(f) (Equation 13)

where \tilde{S}ₑ(f) is the decoded error spectral coefficient, \tilde{S}(f) is the decoded signal spectral coefficient, and S_{syn}(f) is the synthesized signal spectral coefficient from the CELP layer.

As indicated by the following equations, by means of band division section 1001, spectral coefficient division section 1002, multipliers 1004-1 and 1004-2, and adders 1005-1 and 1005-2, the decoded signal spectral coefficients is shaped for each subband in accordance with the spectral envelope shaping parameter to generate the post-processing error signal spectrum.

[14]

if \tilde{S}ₑ(f)=0,

\tilde{S}ₚₒₛₜ_{_{—}}ₑ(f)=\tilde{S}(f)*Pᵢ (Equation 14)

if \tilde{S}ₑ(f)!=0,

\tilde{S}ₚₒₛₜ_{_{—}}ₑ(f)=\tilde{S}ₑ(f)+\tilde{S}(f)*P′ᵢ

fε[sb_start[i],sb_end[i]] (Equation 15)

where \tilde{S}ₑ(f) is the decoded error signal spectral coefficient, \tilde{S}(f) is the decoded signal spectral coefficient, Pᵢ is the spectral envelope shaping parameter for a band in which there is a spectral gap, P′ᵢ is the spectral envelope shaping parameter for a band in which there is no spectral gap, \tilde{S}ₚₒₛₜ_{_{—}}ₑ(f) is the post-processing error signal spectral coefficient, sb_start[i] is the minimum frequency of the ith subband, and sb_end[i] is the maximum frequency of the ith subband.

<Variation>

In the case of a low-bit-rate configuration, a spectral envelope shaping parameter to be used across all bands in which there is no spectral gap may be sent with respect to all bands. The spectral envelope shaping parameter in this case may be calculated as indicated by the equation below.

$$\begin{matrix}( Equation 16 ) & \\ {G}^{′} = \frac{{\sum }_{i = 0}^{{N}_{sb} - 1} {E}_{org \_ i}^{′}}{{\sum }_{i = 0}^{{N}_{sb} - 1} {E}_{dec \_ i}^{′}} & [ 16 ]\end{matrix}$$

where E′_{org}_{_{—}}ᵢ is the energy of the non-zero input signal spectral coefficient in the ith subband, E′_{dec}_{_{—}}ᵢ is the energy of the non-zero decoded signal spectral coefficient in the ith subband, and G′ is the energy ratio of the above-mentioned two energies with respect to the entire band (spectral envelope shaping parameter).

At the audio decoding apparatus, the spectral envelope shaping parameter is used as indicated by the equation below.

[17]

P′i={square root over (\tilde{G}′−1 (Equation 17)

where P′ᵢ is the derived spectral envelope shaping parameter, and \tilde{G}′ is the decoded spectral envelope shaping parameter for the non-zero synthesized signal spectral coefficient.

### Embodiment 3

One important factor in maintaining the sound quality of the input signal is to maintain an energy balance between different frequency bands. Accordingly, it is extremely important that the energy balance between a band that has a spectral gap in the decoded signal and a band that does not be maintained so as to resemble the input signal. What follows is a description of an embodiment capable of maintaining the energy balance between a band that has a spectral gap and a band that does not.

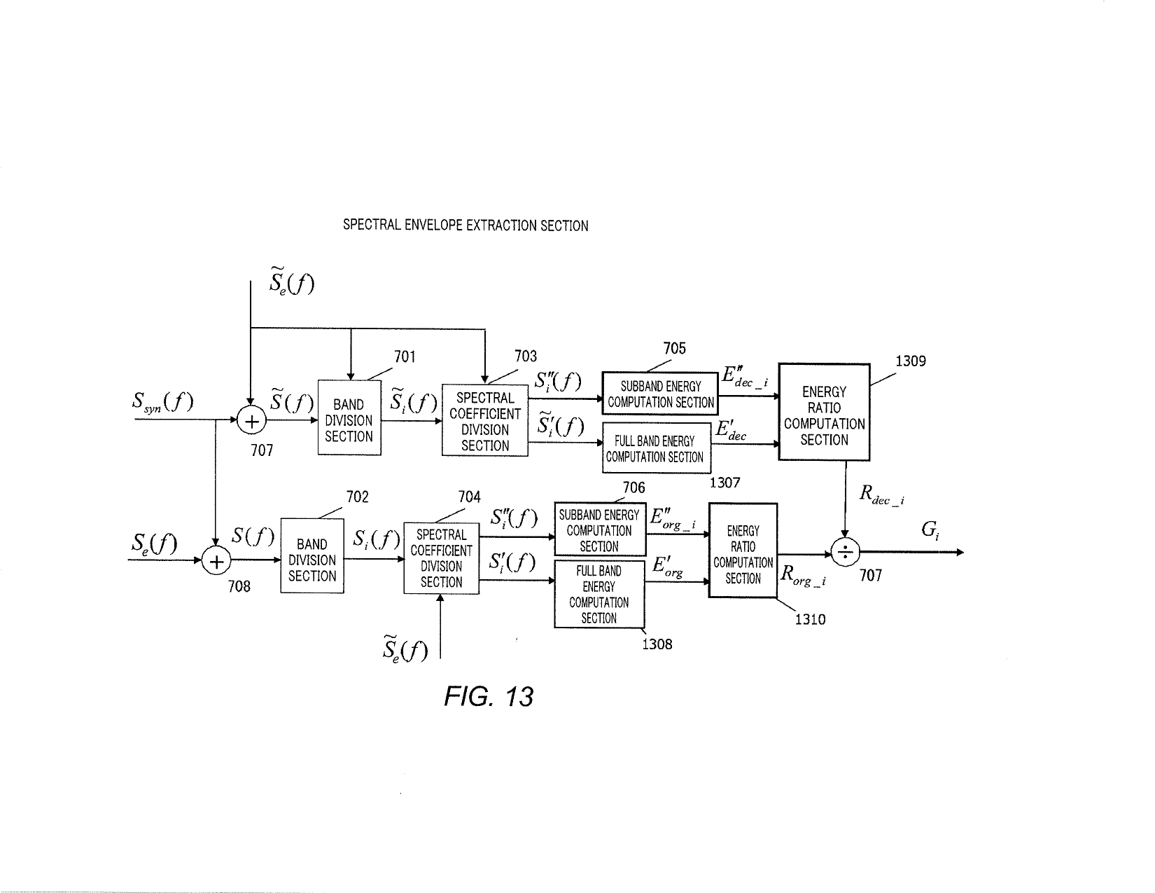

FIG. 13 is a diagram showing a configuration of a spectral envelope extraction section according to the present embodiment. As shown in FIG. 13, full band energy computation sections 1308 and 1307 calculate energy E′_{org} of the non-zero input signal spectral coefficients and energy E′_{dec} of the non-zero decoded signal spectral coefficients. The equations below represent an example energy calculation method.

$$\begin{matrix}( Equation 18 ) & \\ {E}_{org}^{′} = {\sum }_{i = 0}^{{N}_{sb} - 1} {\sum }_{f = 0}^{{N}_{nonzero} [ i ] - 1} {{S}_{i}^{′} ( f )}^{2} & [ 18 ]\end{matrix}$$

where E′_{org} is the energy of the non-zero input signal spectral coefficients with respect to all subbands, S′ᵢ(f) is the non-zero input signal spectral coefficient with respect to the ith subband, N_{sb} is the total number of subbands, and N_{nonzero}[i] is the number of non-zero decoded signal spectral coefficients with respect to the ith subband.

$$\begin{matrix}( Equation 19 ) & \\ {E}_{dec}^{′} = {\sum }_{i = 0}^{{N}_{sb} - 1} {\sum }_{f = 0}^{{N}_{nonzero [ i ]} - 1} {{\tilde{S}}_{i}^{′} ( f )}^{2} & [ 19 ]\end{matrix}$$

where E′_{dec} is the energy of the non-zero decoded signal spectral coefficients with respect to all subbands, Sᵢ(f) is the non-zero decoded signal spectral coefficient with respect to the ith subband, N_{sb} is the total number of subbands, and N_{nonzero}[i] is the number of non-zero decoded signal spectral coefficients with respect to the ith subband.

Energy ratio computation sections 1310 and 1309 calculate an energy ratio relative to the input signal spectral coefficient and an energy ratio relative to the decoded signal spectral coefficient, respectively, according to the equations below.

[20]

R_{org}_{_{—}}ᵢ=E″_{org}_{_{—}}ᵢ/E′_{org} (Equation 20)

where E″_{org}_{_{—}}ᵢ is the energy of the zero input signal spectral coefficients with respect to the ith subband, E′_{org} is the energy of the non-zero input signal spectral coefficients with respect to all subbands, and R_{org}_{_{—}}ᵢ is the energy ratio between the above-mentioned two energies with respect to the ith subband.

[21]

R_{dec}_{_{—}}ᵢ=E″_{dec}_{_{—}}ᵢ/E′_{dec} (Equation 21)

where E″_{dec}_{_{—}}ᵢ is the energy of the zero decoded signal spectral coefficients with respect to the ith subband, E′_{dec} is the energy of the non-zero decoded signal spectral coefficients with respect to all subbands, and R_{dec}_{_{—}}ᵢ is the energy ratio between the above-mentioned two energies with respect to the ith subband.

At divider 707, a spectral envelope shaping parameter is computed as indicated by the following equation.

[22]

Gᵢ=R_{org}_{_{—}}ᵢ/R_{dec}_{_{—}}ᵢ (Equation 22)

where R_{org}_{_{—}}ᵢ is the energy ratio of the input signal spectrum corresponding to the ith subband, R_{dec}_{_{—}}ᵢ is the energy ratio of the decoded signal spectrum corresponding to the ith subband, and Gᵢ is the ratio between the above-mentioned two energy ratios.

### Embodiment 4

In the case of a configuration where coding is performed at a low bit rate, coding accuracy is sometimes insufficient even for bands where there is no spectral gap (i.e., bands coded at a transform coding layer), resulting in a large coding error relative to the input signal spectral coefficient. Under such conditions, it is possible to improve sound quality by applying spectral envelope shaping to bands where there is no spectral gap, just like it is applied to bands where there is a spectral gap. The present embodiment is one where this idea has been applied to Embodiment 3.

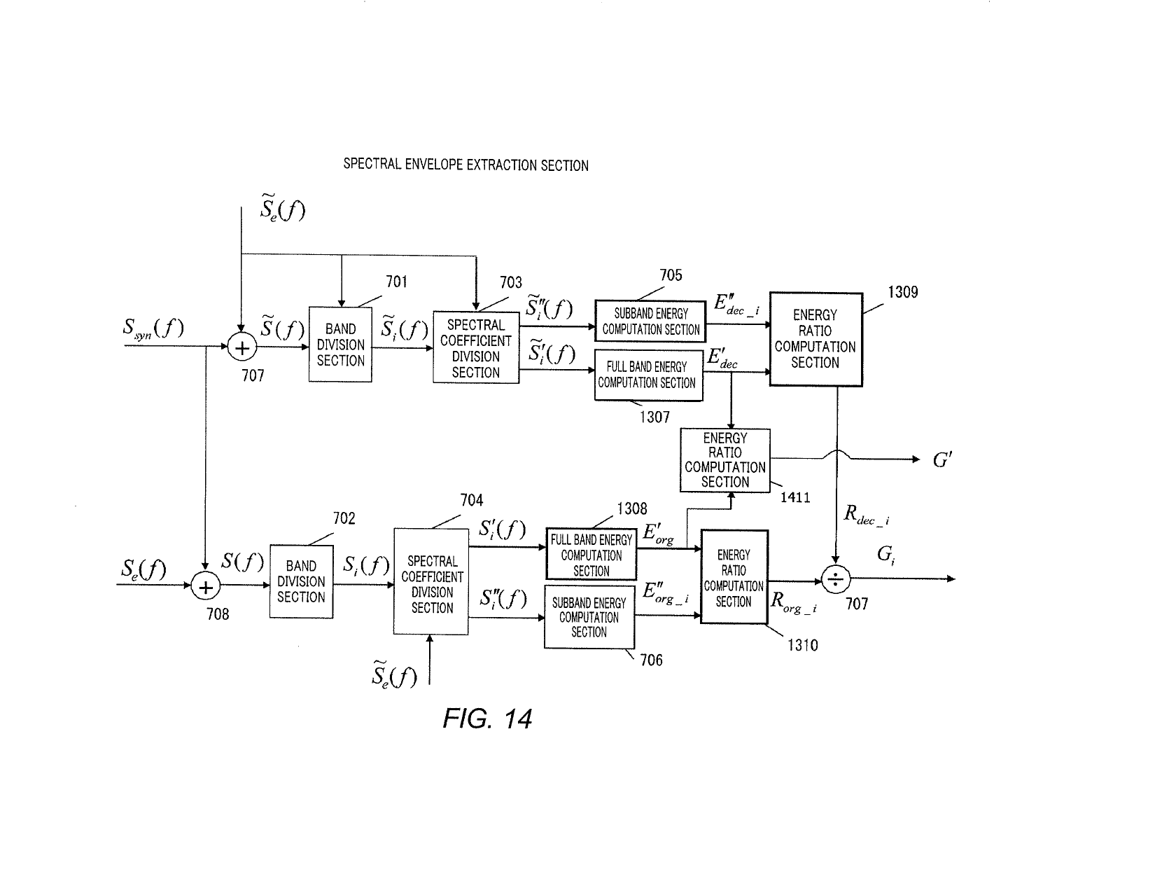

FIG. 14 is a diagram showing a configuration of a spectral envelope extraction section according to the present embodiment. As shown in FIG. 14, energy ratio computation section 1411 determines, as G′, the energy ratio of energy E′_{org} of the non-zero input signal spectral coefficients to energy E′_{dec} of the non-zero decoded signal spectral coefficients. Energy ratio G′ thus computed is also outputted as a spectral envelope shaping parameter.

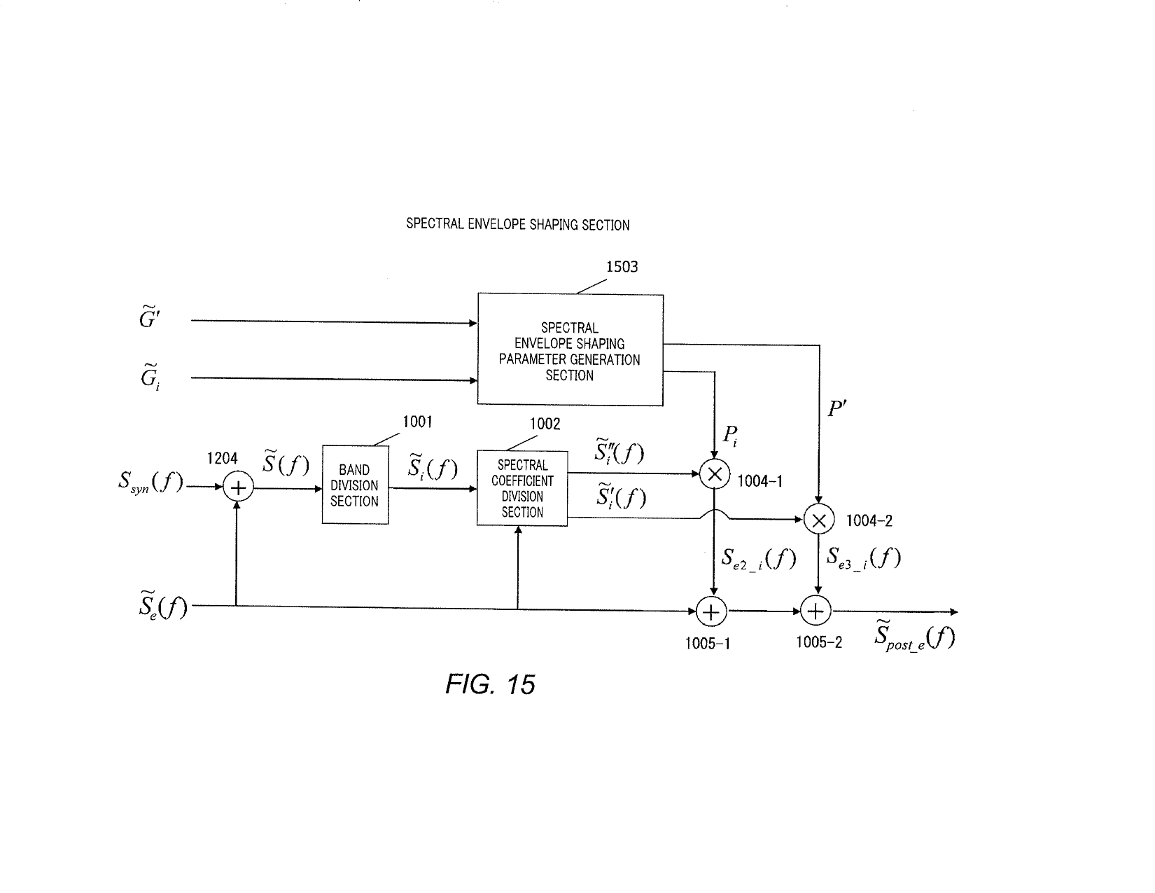

FIG. 15 is a diagram showing a configuration of a spectral envelope shaping section with respect to the present embodiment. Spectral envelope shaping parameter generation section 1503 calculates a spectral envelope shaping parameter for a band in which there is no spectral gap in the manner indicated by the following equation.

[23]

Pᵢ={square root over (\tilde{G}ᵢ/\tilde{G}′−1 (Equation 23)

where Pᵢ is the obtained spectral envelope shaping parameter, \tilde{G}ᵢ is the decoded energy ratio with respect to the ith subband, and \tilde{G}′ is the decoded energy ratio with respect to non-zero spectral coefficients.

Embodiments 1 through 4 of the present invention have been described above.

For these embodiments, the apparatuses were referred to as audio coding apparatuses/audio decoding apparatuses, but the term “audio” as used herein refers to audio in a broad sense. Specifically, an input signal with respect to an audio coding apparatus and a decoded signal with respect to an audio decoding apparatus may include any kind of signal, e.g., an audio signal, a music signal, or an acoustic signal including both of the above, and so forth.

The embodiments above have been described taking as examples cases where the present invention is configured with hardware. However, the present invention may also be realized through software in cooperation with hardware.

The functional blocks used in the descriptions for the embodiments above are typically realized as LSIs, which are integrated circuits. These may be individual chips, or some or all of them may be integrated into a single chip. Although the term LSI is used above, depending on the level of integration, they may also be referred to as IC, system LSI, super LSI, or ultra LSI.

The method of circuit integration is by no means limited to LSI, and may instead be realized through dedicated circuits or general-purpose processors. Field programmable gate arrays (FPGAs), which are programmable after LSI fabrication, or reconfigurable processors, whose connections and settings of circuit cells inside the LSI are reconfigurable, may also be used.

Furthermore, should there arise a technique for circuit integration that replaces LSI due to advancements in semiconductor technology or through other derivative techniques, such a technique may naturally be employed to integrate functional blocks. Applications of biotechnology, and/or the like, are conceivable possibilities.

The disclosure of the specification, drawings, and abstract included in Japanese Patent Application No. 2010-234088, filed on Oct. 18, 2010, is incorporated herein by reference in its entirety.

### INDUSTRIAL APPLICABILITY

The present invention is applicable to wireless communications terminal apparatuses, base station apparatuses, teleconference terminal apparatuses, video conference terminal apparatuses, voice over Internet Protocol (VoIP) terminal apparatuses, and/or the like, of mobile communications systems.

### REFERENCE SIGNS LIST

601 CELP coding section
602 CELP local decoding section
603, 604 T/F transform section
605 Vector quantization section
606 Vector dequantization section
607 Vector envelope extraction section
608 Quantization section
609 Multiplexing section
901 Demultiplexing section
902 CELP decoding section
903 T/F transform section
904 Vector dequantization section
905 Dequantization section
906 Spectral envelope shaping section
907 F/T transform section
908 Adder

1. An audio coding apparatus comprising:
a first coding section that codes an input signal and generates first coded data;
a first local decoding section that decodes the first coded data, and generates a first decoded signal;
a subtractor section that subtracts the first decoded signal from the input signal, and generates an error signal;
a second coding section that codes only a portion of spectral coefficients of the error signal, and generates second coded data;
a spectral envelope shaping parameter calculation section that calculates a spectral envelope shaping parameter; and
a quantization section that quantizes the spectral envelope shaping parameter, and generates third coded data.

2. The audio coding apparatus according to claim 1, wherein the spectral envelope shaping parameter calculation section comprises:
a second local decoding section that generates, from the second coded data, decoded error signal spectral coefficients comprising zero decoded error signal spectral coefficients and non-zero decoded error signal spectral coefficients;
an adder section that adds spectral coefficients of the first decoded signal and the decoded error signal spectral coefficients, and generates decoded signal spectral coefficients;
a first energy calculation section that calculates an input signal energy of spectral coefficients of the input signal;
a second energy calculation section that calculates a decoded signal energy of the decoded signal spectral coefficients; and
an energy ratio calculation section that calculates an energy ratio between the input signal energy and the decoded signal energy.

3. The audio coding apparatus according to claim 1, wherein the spectral envelope shaping parameter calculation section comprises:
a second local decoding section that generates, from the second coded data, decoded error signal spectral coefficients comprising zero decoded error signal spectral coefficients and non-zero decoded error signal spectral coefficients;
an adder section that adds spectral coefficients of the first decoded signal and the decoded error signal spectral coefficients, and generates decoded signal spectral coefficients;
a first energy calculation section that calculates an input signal energy of spectral coefficients of the input signal corresponding to the zero decoded error signal spectral coefficients;
a second energy calculation section that calculates a decoded signal energy of the decoded signal spectral coefficients corresponding to the zero decoded error signal spectral coefficients; and
an energy ratio calculation section that calculates an energy ratio between the input signal energy and the decoded signal energy.

4. The audio coding apparatus according to claim 1, wherein the spectral envelope shaping parameter calculation section comprises:
a second local decoding section that generates, from the second coded data, decoded error signal spectral coefficients comprising zero decoded error signal spectral coefficients and non-zero decoded error signal spectral coefficients;
an adder section that adds spectral coefficients of the first decoded signal and the decoded error signal spectral coefficients, and generates decoded signal spectral coefficients;
a first energy calculation section that calculates an input signal energy of spectral coefficients of the input signal corresponding to the non-zero decoded error signal spectral coefficients; and
a second energy calculation section that calculates a decoded signal energy of the decoded signal spectral coefficients corresponding to the non-zero decoded error signal spectral coefficients.

5. The audio coding apparatus according to claim 1, wherein the spectral envelope shaping parameter calculation section comprises:
a second local decoding section that generates, from the second coded data, decoded error signal spectral coefficients comprising zero decoded error signal spectral coefficients and non-zero decoded error signal spectral coefficients;
an adder section that adds spectral coefficients of the first decoded signal and the decoded error signal spectral coefficients, and generates decoded signal spectral coefficients;
a first energy calculation section that calculates a first input signal energy of spectral coefficients of the input signal corresponding to the non-zero decoded error signal spectral coefficients;
a second energy calculation section that calculates a first decoded signal energy of the decoded signal spectral coefficients corresponding to the non-zero decoded error signal spectral coefficients;
a first energy ratio calculation section that calculates a first energy ratio between the first input signal energy, which corresponds to the non-zero decoded error signal spectral coefficients, and the first decoded signal energy, which corresponds to the non-zero decoded error signal spectral coefficients;
a third energy calculation section that calculates a second input signal energy of spectral coefficients of the input signal corresponding to the zero decoded error signal spectral coefficients;
a fourth energy calculation section that calculates a second decoded signal energy of the decoded signal spectral coefficients corresponding to the zero decoded error signal spectral coefficients; and
a second energy ratio calculation section that calculates a second energy ratio between the second input signal energy and the second decoded signal energy.

6. The audio coding apparatus according to claim 5, wherein the spectral envelope shaping parameter calculation section further comprises a ratio calculation section that calculates a ratio between the second energy ratio and the first energy ratio.

7. The audio coding apparatus according to claim 1, wherein the first coding section codes the input signal using code-excited linear prediction.

8. The audio coding apparatus according to claim 1, wherein the second coding section codes only a portion of the spectral coefficients of the error signal using vector quantization.

9. The audio coding apparatus according to claim 8, wherein, using the vector quantization, the second coding section codes the spectral coefficients that are represented by a limited number of pulses.

10. The audio coding apparatus according to claim 1, further comprising:
a band division section that performs band division where the spectral coefficients are divided into a plurality of subbands; and
a band determination section that determines, of the plurality of subbands, a portion of subbands that requires spectral envelope shaping, wherein
the spectral envelope shaping parameter calculation section calculates the spectral envelope shaping parameter for the portion of subbands.

11. The audio coding apparatus according to claim 10, wherein the band division section performs the band division in accordance with available bits so as to:
divide the spectral coefficients into a greater number of subbands if the available bits are abundant; and
divide the spectral coefficients into a fewer number of subbands if the available bits are small in number.

12. The audio coding apparatus according to claim 10, further comprising a sender section that sends a flag signal indicating the portion of subbands that was subject to calculation by the spectral envelope shaping parameter.

13. An audio decoding apparatus comprising:
a first decoding section that decodes first coded data and generates a first decoded signal;
a second decoding section that decodes second coded data, and generates decoded error signal spectral coefficients comprising zero decoded error signal spectral coefficients and non-zero decoded error signal spectral coefficients;
a first adder section that adds spectral coefficients of the first decoded signal and the decoded error signal spectral coefficients, and generates decoded signal spectral coefficients;
a dequantization section that dequantizes third coded data and generates a decoded spectral envelope shaping parameter;
a spectral envelope shaping section that shapes the decoded signal spectral coefficients using the decoded spectral envelope shaping parameter, and generates a shaped decoded signal spectral coefficient;
a second adder section that adds the decoded error signal spectral coefficients and the shaped decoded signal spectral coefficients, and generates a post-processing error signal; and
a third adder section that adds the first decoded signal and the post-processing error signal, and generates an output signal.

14. The audio decoding apparatus according to claim 13, wherein the first decoding section decodes the first coded data using code-excited linear prediction.

15. The audio decoding apparatus according to claim 13, wherein the second decoding section decodes the second coded data using vector dequantization.

16. The audio decoding apparatus according to claim 15, wherein, using the vector dequantization, the second decoding section decodes error signal spectral coefficients that are represented by a limited number of pulses.

17. The audio decoding apparatus according to claim 13, further comprising:
a band division section that performs band division where the decoded error signal spectral coefficients are divided into a plurality of subbands; and
a band determination section that determines, of the plurality of subbands, a portion of subbands that requires spectral envelope shaping, wherein
the dequantization section generates the decoded spectral envelope shaping parameter only with respect to the portion of subbands, and
the spectral envelope shaping section shapes the decoded signal spectral coefficients only with respect to the portion of subbands.

18. The audio decoding apparatus according to claim 17, wherein the band determination section determines the portion of subbands in accordance with a flag signal indicating the portion of subbands that requires the spectral envelope shaping.

19. An audio coding method comprising:
generating first coded data by coding an input signal;
generating a first decoded signal by decoding the first coded data;
generating an error signal by subtracting the first decoded signal from the input signal;
generating second coded data by coding only a portion of spectral coefficients of the error signal;
calculating a spectral envelope shaping parameter; and
generating third coded data by quantizing the spectral envelope shaping parameter.

20. An audio decoding method comprising:
generating a first decoded signal by decoding first coded data;
generating, by decoding second coded data, decoded error signal spectral coefficients comprising zero decoded error signal spectral coefficients and non-zero decoded error signal spectral coefficients;
generating decoded signal spectral coefficients by adding spectral coefficients of the first decoded signal and the decoded error signal spectral coefficients;
generating a decoded spectral envelope shaping parameter by dequantizing third coded data;
generating shaped decoded signal spectral coefficients by shaping the decoded signal spectral coefficients using the decoded spectral envelope shaping parameter;
generating a post-processing error signal by adding the decoded error signal spectral coefficients and the shaped decoded signal spectral coefficients; and
generating an output signal by adding the first decoded signal and the post-processing error signal.
